(19) United States
(12) Patent Application Publication
(10) Pub. No.: US 2020/0245659 A1
(43) Pub. Date: Aug. 6, 2020

(54) POTATO EMULSION

(71) Applicant: VEG OF LUND AB, Malmö (SE)

(72) Inventor: Eva TORNBERG, Lund (SE)

(73) Assignee: VEG OF LUND AB, Malmö (SE)

(21) Appl. No.: 16/652,075

(22) PCT Filed: Oct. 2, 2018
(86) PCT No.: PCT/SE2018/051007

§ 371 Date: Mar. 30, 2020

(30) Foreign Application Priority Data
Oct. 4, 2017 (SE) 1751224-5

(51) Int. Cl. A23L 19/00; A23L 19/15; A23L 2/02; A23L 35/00

(52) U.S. Cl. CPC A23L 19/09; A23L 19/15; A23L 2/52; A23L 35/10; A23L 2/02

(57) ABSTRACT

The present invention relates to stable vegetable emulsions, particularly potato containing emulsions. These emulsions, providing a good taste and a sensory mouthfeel, without any graininess, are to be used in products like smoothies as fruit and vegetable containing beverages, soups, and sauces. Also a method to prepare the stable vegetable emulsion is presented.

### TECHNICAL FIELD

The present invention relates to stable vegetable emulsions, more particularly it relates to potato containing emulsions. These emulsions are to be used in smoothies as fruit and vegetable containing beverages, soups, and sauces.

The present invention further relates to a method to prepare a stable vegetable emulsion.

### BACKGROUND

In SE 534 856 it is disclosed a vegetable emulsion comprising ingredients like vegetable oil, potato, and fruit. The emulsion is then provided as smoothie, dessert, or yoghurt. It is herein disclosed that by using vegetable oils having a high content of omega-3 fatty acids, and a vegetabilic alternative to commonly used fish oil is provided. Also it is shown that it is possible to avoid additives with origin in milk, which is an advantage for individuals having allergies or being intolerant to milk containing products. From an environmental horizone it might also be considered important to reduce the consumption of milk based products.

In patent SE 534 856 it has been shown that potato can be a useful ingredient in emulsions, smoothies and soups. Potato comprises mainly proteins and starch, which are important ingredients in the formation of an emulsion, when preparing the smoothie from a source of potato and at least one vegetable oil. The protein emulsifies the oil and stabilises the emulsion, whereas the starch gives rise to a viscous water phase, which is important for the mouthfeel and also hinder water separation of the smoothie.

However, there is still a need to improve the stability of the emulsion, to avoid a separation of water- and oil phase. There is a need to improve the taste and mouthfeel of potato containing products like emulsions, smoothies, and soups.

The invention presented herein shows that the processing (mainly the heat treatment) of the potato raw material is of great importance for the properties of the potato emulsion. Important properties of the potato emulsion is stability against water- and fatseparation, sensory properties like a smooth mouthfeel and no graininess and a good consistency. The underlying characteristics that govern these properties are the structure and the particle size distribution (PSD) of the oil droplets and the starch granules and how much of the starch that is in the cell or outside, the latter called extracellular starch. In for example Lamberti, M., et al., ‘Starch transformation and structure development in production and reconstitution of potato flakes’, Lebensm.-Wiss. U.-Technol. 37 (2004) 417-427, it is shown that processing of the potato influence the integrity of the cells, wherein the starch granules are kept

Further, herein it is indicated the importance of keeping the extracellular starch fraction as low as possible. Also the cells behaviour, being clustered or the degree of being clustered, affect the properties of the product. Consequently, there is a need to provide more insight how processing of the potato influence the vegetable potato based emulsions in order to be able to govern its stability and sensory properties.

### SUMMARY OF THE INVENTION

The present invention relates to a stable potato based emulsion wherein the potato has been processed (mainly heat treated) before mixing with the other ingredients, like vegetable oil, fruit or vegetables, to form the emulsion. The emulsion has further the advantage of giving a good taste and a sensory mouthfeel.

One object of the present invention is to provide a stable, potato based emulsion comprising:

a) 1-40% by weight of at least one vegetable oil;

b) 1-65% by weight of heat treated potato source, wherein the heat treated potato is chosen from potato flakes heated to at least 100° C. or whole and/or potato cubes pasteurized at 98° C., or autoclaved at about 115-121° C.;

c) 5-30% by weight of at least one fruit or vegetable; and

d) optionally adding water up to 100% by weight;

wherein oil drops present in the emulsion have a diameter (d32) of less than 90 μm and starch particles originating from the heat treated potato have a diameter (D43) of less than 250 μm. In general, it is an aim to have swollen starch granules in the cells, which in turn are separated and not associated. The potato based emulsion as above is stable against water- and fat separation and has a smooth mouthfeel and a good taste.

The potato source to be included in the emulsion is heat treated, for example, it is heated to a temperature of about 98-100° C. (pasteurized) or for example it is heated to a temperature of 115-121° C. (autoclaved). When the potato source is in the form of whole potato or potato cubes it is either pasteurized at 98° C. for 25-30 min with a total heating time of 68 min or heated by autoclaving at about 115-121° C. (pressure of 2 bar) for 32 min with a total heating time of 55-60 min.

The potato source can also be available as potato flakes and the pre-cooking is done to get the starch to gelatinize within the potato cell, but not allow the softening of the intracellular bonds to take place. The process of a continuous screw through a processing unit heated usually does this by the direct injection of steam. After that drum drying is performed with a potato slurry of 12%, working under atmospheric pressure with a steam pressure of 2 to 7 kg/cm² (saturation temperature 120-164° C.). The potato slurry is dehydrated down to a water content of about 8% by evaporation at 100° C. With a pre-treatment like above of the potato raw material a stable potato emulsion is achieved with oil droplet sizes below 90 μm and starch granules below 250 μm and with a smooth mouthfeel.

Another object of the present invention is to provide a stable emulsion comprising at least one vegetable oil chosen from rapeseed oil, olive oil, maize oil, sunflower oil, soybean oil, coconut oil, peanut oil, and sesame oil.

The use of a vegetable oil gives an emulsion as an alternative to the animal based milk and milk products.

Another object of the present invention is to provide a stable emulsion comprising at least one fruit chosen from apple, banana, citrus fruit, pear, pineapple, mango, passion fruit, papaya, or berry chosen from strawberry, raspberry, blueberry, black currant, red currant, sea buckthorn, blackberry, and lingonberry. Alternatively, the stable emulsion according to the present invention may comprise at least one vegetable chosen from onion, broccoli, parsnip, carrot, mushroom, tomato, leek, red beat.

Another object of the present invention is a stable potato based emulsion as described above, and wherein said oil drops have a diameter (d32) of 20-90 μm. For example, the said oil drops have a diameter (d32) of 30-80 μm, or a diameter (d32) of 30-70 μm. Another example is 30-40 μm.

The smaller the oil droplets the more stable is the emulsion and the smoother the mouthfeel.

An object of the invention is to provide a stable, potato based emulsion as defined above, wherein the majority of the starch particles are non-associated.

It is an advantage to have non-associated starch particles as it has been experienced that the more associated and clustered the starch granules the larger the experienced starch granules in the mouth and the more grainy is the sensory mouthfeel.

Another advantage achieved by having the majority of the starch in non-associated form is that the number of starch granules is then higher at the same content of starch and then the probability is increased to form a network of starch granules, which is the basis for the starch granules to form a viscous water phase. The more viscous the water phase of the emulsion the less water separation.

One object of the invention is to provide a stable, potato based emulsion as above, wherein the starch particles have a diameter of 100-250 μm, for example, a diameter of 100-200 μm, such as a diameter of 120-190 μm, or a diameter of 140-170 μm.

A stable, potato based emulsion comprising starch particles of the above defined size gives a good smooth mouthfeel and a viscous water phase hindering water separation.

### DEFINITIONS

By the term “heat treated potato” it is herein meant a source of potato being heated to above 95° C., such as to about 98-100° C. and 115-121° C.

By the term “vegetable oil” it is meant oil that is obtained from vegetabilic sources. The preferred sources are further described below.

By the term ‘source of potato’ and ‘potato’ it is herein meant potato in any form and from any origin. The potato may for example be in the form of potato flakes or as whole potato or in potato cubes. However, there is no limitations in the form of the potato.

By the term “potato flake” it is herein meant whitish flakes, where 30-65% of the flakes have a size of 1-3 mm.

By the term “potato cube” it is herein meant cubes of potato with about 10 mm side length.

### DETAILED DESCRIPTION

In particular, the present invention relates to stable potato based emulsions comprising

a) 1-40% by weight of at least one vegetable oil;

b) 1-65% by weight of heat treated potato, wherein the heat treated potato is chosen from potato flakes heated to at least 100° C. or whole and/or potato cubes pasteurized at 98° C., or autoclaved at about 115-121° C.;

c) 5-30% by weight of at least one fruit or vegetable; and

d) optionally water up to 100%,

wherein oil drops present in the emulsion have a diameter (d32) of less than 90 μm and starch particles originating from the heat treated potato have a diameter (D43) of less than 250 μm.

The at least one vegetable oil is present in an amount of between 1-40% by weight, for example the at least one vegetable oil is present in an amount of 1, 2, 3, 4, 5, 6, 10, 12, 15, 20, 25, 30, 35, or 40% by weight. More specifically, the at least one vegetable oil is present in an amount of 6% oil using rapeseed oil having 10% of omega 3. Thereby, the requirement set by the authority (European Food Safety Authority, EFSA) of having 0.6% omega 3 to be able to declare “rich in omega 3” is met.

The at least one vegetable oil is preferably chosen from rapeseed oil, olive oil, maize oil, sunflower oil, soybean oil, coconut oil, peanut oil, sesame oil, linseed oil, avocado oil, walnut oil, pistachio oil, and hazelnut oil. It will be understood that also different combinations of vegetable oils can be chosen to be included in the emulsion.

The source of potato is present in an amount of 1-65% by weight. For example potato is present in an amount of 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 35, 40, 45, 50, 55, 60 and 65% by weight. Preferably, the emulsion comprises potato in an amount of 2, 3, 4, 5, 6, 8, 10, 13, 17, 20, 22, 24, 26, 30, and 55%.

The emulsion of the present invention comprises a source of potato which is heat treated. The source of potato can be pretreated and provided in form of potato flakes. It can also be provided in the form of whole potato and/or potato cubes.

It has been found that when potato flakes are chosen to be included in the emulsion the source of potato is heated to at least 100° C. during evaporation. It has also been found that when the source of potato is in the form of whole potato and/or potato cubes they shall be either pasteurized at 98° C. for 25-30 min with a total heating time of 68 min. or heated by autoclaving at about 115-121° C. (pressure of 2 bar) for 32 min. with a total heating time of 55-60 min. The potato based emulsion of the invention comprises further 3-30% by weight of at least one fruit or vegetable. The fruit to be included is chosen from apple, banana, citrus fruit, pear, pineapple, mango, passion fruit, papaya, or berry chosen from strawberry, raspberry, blueberry, black currant, red currant, sea buckthorn, blackberry, and lingonberry. The vegetable to be included may be chosen from onion, broccoli, parsnip, carrot, mushroom, tomato, leek, red beat. Also combinations of one or more fruits and vegetables can be used. The emulsion may also include combinations of both fruits and vegetables. Examples of combinations are: apple and raspberry, apple and blueberry, apple and sea buckthorn, onion and leek, onion and tomato, and onion and broccoli. The list of possible combinations is not exhaustive and shall not be considered as a limitation.

The emulsion obtained may also contain further ingredients, for example, one or more spices. Examples of spices to be included are salt, black pepper, cayenne pepper, garlic, thyme, bay leaves, wild garlic, fungus powder and ramson. Also aromatic ingredients may be added, like vanilla, fruit aroma, etc. The lists of ingredients are not exhaustive, but also other spices can be included in the emulsion herein defined. Spices are preferably added when the emulsion contains at least one vegetable. The stable potato based emulsion of the invention shall comprise oil droplets of a well defined size. It has been found that the oil drops shall have a diameter (d32) of less than 90 μm, preferably a diameter within the interval of 20 to 90 μm, for example a diameter of 30 to 80 μm, such as between 30 to 50 μm, or a diameter of 30-40 μm.

It has been found that by a careful heat treatment of the source of potato it is possible to improve the sensory mouthfeel of the emulsion. By the heat temperature herein described it is possible to obtain an emulsion containing starch particles having a diameter (d43) of 100-250 μm, such as a diameter of 100-200 μm, eg 120-190 μm, or a diameter of 140-170 μm.

Further, it has also been found that the heat treatment gives a product wherein the majority of the starch particles are non-associated. That means that they appear as single particles instead of clusters of particles which together have a size larger than the particles defined above. This has been shown important when considering the taste and sensory mouthfeel. If larger particles are formed in the emulsion a disagreeable feeling of graininess may appear. It has also been shown that the emulsions herein described are stable also at elevated temperature.

### BRIEF DESCRIPTION OF THE FIGURES

FIG. 1, A-F, shows light micrographs of starch granules present in emulsions made of different kinds of potato.

In A—the source of potatoe is Standard potato flakes;

In B—the source of potato is Eko Kebelco potato flakes;

In C—the source of potato is blanched frozen potato cubes;

In D—the source of potato is Swedish Autoclaved Potato cubes;

In E—the source of potato is Eko autoclaved potato cubes;

In F—the source of potato is Swedish pasteurised potato cubes.

FIGS. 2-7 show the particle size (μm) as a function of the oil (%) and protein (%) content of the emulsions according to the compositions defined in the Examples.

FIGS. 8-15 show the viscosity (G′ (Pa)) as function of the oil and protein content (%) of the emulsions according to the compositions defined in the Examples.

### EXAMPLES

By way of examples, and not limitation, the following examples identify a variety of beverage compositions pursuant to embodiments of the present invention.

A source of potato is included in the emulsion and the smoothie as described and defined herein. The potato to be included in the composition may be prepared and treated before its mixing with other ingredients to form the final product.

Depending on the source of potato as well as its pre-treatment the grainy mouthfeel can change.

Preferably, a smoothie shall have a nice and smooth mouthfeel without any peculiar feeling of details in the smoothie.

Further, the main ingredients, i.e. the source of potato or the the apple pure and/or apple juice will neither give a dominating taste, when the smoothie contains fruit and/or vegetables which are supposed to give the main taste. The emulsion may also contain additives, like spices etc to emphasize the taste, to make the emulsion and the smoothie more well-tasting.

### Preparation of Source of Potato

Different sources of potatoes were prepared according to the following:

Potato flakes in size of 1-3 mm were provided by Eko Kebelco and Standard from Engelhardt;

Potato cubes of Magnihill were blanched (95° C., 5 min) and frozen;

Potato cubes (10×10×10 mm) of Eko Vättern potato, Swedish vättern potato were autoclaved at about 115-121° C., pressure 2 bar, for 32 minutes. The total heating time was of about 55-60 minutes;

Potato cubes of Vättern potato were pasteurised at 98° C., for 25-30 minutes; the total heating time was about 68 minutes.

The different source of potato used in the experiments were firstly characterised with respect to the dry matter (DM (%)) and the protein content (Protein (%)).

The dry matter (DM) or the source of potato was determined by weighing the sample before and after drying in an oven at 102° C. overnight. Protein content of the source of potato was measured using FlashEA® 1112 N/protein Analyser based on the principle of pyrolysis.

The results are presented in Table 1.

TABLE 1

| Type of potato | DM (%) | Protein (%) |
|---|---|---|
| Potato flakes: | | |
| Eko Kebelco | 92.5 | 6.9 |
| Standard | 92.4 | 6.1 |
| Blanched-frozen Potato | | |
| cubes | | |
| Magnihill | 15.5 | 1.0 |
| Autoclaved Potato | | |
| cubes: | | |
| Eko Vättern potato | 12.7 | 0.78 |
| Swedish Vättern potato | 19.5 | 1.1 |
| Pasteurised potato | | |
| cubes: | | |
| Vättern potato | 17.2 | 0.90 |

From Table 1 it can be seen that the protein content is about 1% for the potato cubes, whereas the potato flakes have a 6 times higher protein content due to the increased dry matter (DM). The increase of dry matter in the potato flakes is about 5 times compared to the potato cubes.

When included in a smoothie, the potato flakes (standard and Eko Kebelco) show separated cells, i.e. non-associated cells, with a swelled granule therein, the blanched and frozen product (Magnihill) shows, however, associated cells of potato with the swollen granule therein. The Swedish autoclaved potato cubes and the Eko autoclaved potato cubes have non-associated sole cells containing a swollen granule therein like the potato flakes, but with more extracellular starch. Ultimately, the Swedish pasteurised potato cubes also have non-associated cells with the swelled starch granule therein, but do not seem to have any extra-cellular starch as the autoclaved potatoes.

When testing the taste and sensory mouthfeel of the smoothies, it appeared that the blanched and frozen potato cubes gave a grainy mouthfeel compared to the other sources of potatoes and ways of treatment.

Water separation could sometimes be observed in the smoothies and that was most evident, when using the blanched and frozen potato. The autoclaved potato gave less occurent water separation, whereas the potato flakes and pasteurised potato cubes gave rise to least separation. This observation suggests that least separation occurs in the smoothie when the swelled starch granules are within the cell and when the cells are non-associated.

The emulsion herein described contains the following ingredients:

a) at least one vegetable oil;

b) heat treated potato;

c) at least one fruit or vegetable;

d) optionally water up to 100% by weight; and

e) optionally further ingredients like minor amounts of colour and taste enhancers, like aromatic ingredients or spices.

The source of potato, in the form of whole potato and/or potato cubes, or in form of potato flakes, is heat treated before preparing the emulsion. The emulsion is prepared according to the following general procedure (Example A):

1) providing the ingredients to be included in the emulsion in suitable amounts;

2) pouring a certain amount of the potato solution into a falcon tube (50 ml);

3) adding at least one vegetable oil;

4) shaking;

5) making an emulsion by intense stirring (turbo rex, speed 5, for 1 minute);

6) checking the particle size distribution (PSD) and microscopy as described below.

A general procedure for preparing a smoothie may include the following steps (Example B).

A smoothie is prepared according to the following steps:

1) providing the ingredients to be included in the smoothie in suitable amounts;

2) mixing the ingredients to be included in the smoothie to form an emulsion;

3) blending the mixture of step1) (hand blender for about 2 minutes);

4) adding additional optional ingredients for dilution;

5) mixing (for 30 seconds);

6) check the PSD and microscopy; and

7) checking the consistency as described below

A general procedure (Example C) for preparing a soup includes the following steps:

1) providing the ingredients to be included in the soup in suitable amounts;

2) mixing all ingredients and blend it using a hand blender for 2 minutes;

3) checking the PSD and microscopy; and

4) checking the consistency as described below Smoothies have been produced according to the method above, with different content of protein and oil. The particle size of the emulsion droplets and the potato cells with the swelled potato granule therein have been measured.

For the examples of potato emulsions given below the following recipes have been used with regard to type of potato used:

### Example 1—Standard Potato Flakes

| Raw material | Percentage |
|---|---|
| A: 0.15% protein | |
| Potato flakes | 2.5 |
| Rapeseed oil | 6.0 |
| Water | 91.5 |
| B: 0.25% protein | |
| Potato flakes | 4.1 |
| rapeseed oil | 6.0 |
| Water | 89.9 |
| C: 0.50% protein | |
| Potato flakes | 8.2 |
| rapeseed oil | 6.0 |
| Water | 85.8 |

When varying the oil content of the emulsion from 1 to 40% the oil has been exchanged with water up to 100% emulsion.

### Example 2: Eko Kebelco Potato Flakes

| Raw material | Percentage |
|---|---|
| A: 0.25% protein | |
| Potato flakes | 3.6 |
| rapeseed oil | 6.0 |
| Water | 90.4 |
| B: 0.50% protein | |
| Potato flakes | 7.2 |
| rapeseed oil | 6.0 |
| Water | 86.8 |

When varying the oil content from 1 to 40% the oil has been exchanged with water up to 100% emulsion.

### Example 3: Blanched frozen Potato Cubes

| 0.17% protein | |
|---|---|
| Raw material | Percentage |
| Potato cubes | 17.0 |
| rapeseed oil | 6.0 |
| Apple juice | 77.0 |

When varying the oil content from 3 to 20% the oil has been exchanged with apple juice up to 100% emulsion.

### Example 4: Swedish Autoclaved Potato Cubes

| Raw material | Percentage |
|---|---|
| A: 0.15% protein | |
| Potato cubes | 13.6 |
| rapeseed oil | 6.0 |
| Water | 80.4 |
| B: 0.25% protein | |
| Potato cubes | 22.7 |
| rapeseed oil | 6.0 |
| Water | 71.3 |
| C: 0.50% protein | |
| Potato cubes | 45.5 |
| rapeseed oil | 6.0 |
| Water | 48.5 |

When varying the oil content from 1 to 40% the oil has been exchanged with water up to 100% emulsion.

### Example 5: Eko Autoclaved Potato Cubes

| Raw material | Percentage |
|---|---|
| A: 0.25% protein | |
| Potato cubes | 32.1 |
| rapeseed oil | 6.0 |
| Water | 61.9 |
| B: 0.50% protein | |
| Potato cubes | 64.1 |
| rapeseed oil | 6.0 |
| Water | 29.9 |

When varying the oil content from 1 to 40% the oil has been exchanged with water up to 100% emulsion.

### Example 6: Swedish Pasteurised Potato Cubes

| Raw material | Percentage |
|---|---|
| A: 0.15% protein | |
| Potato cubes | 16.7 |
| rapeseed oil | 6.0 |
| Apple juice | 77.3 |
| B: 0.25% protein | |
| Potato cubes | 27.8 |
| rapeseed oil | 6.0 |
| Apple juice | 66.2 |
| C: 0.50% protein | |
| Potato cubes | 55.6 |
| rapeseed oil | 6.0 |
| Apple juice | 38.4 |

When varying the oil content from 1 to 40% the oil has been exchanged with apple juice up to 100% emulsion.

The starch granules present in the emulsion and the smoothie may appear in different ways depending on its origin and the pretreatment of the source of potato. Potato in different forms were provided and investigated using light microscopy to study the morphology of the potato cells. The potato tested were the following:

A: standard potato flakes;

B: Eko Kebelco potato flakes;

C: Blanched frozen Potato cubes;

D: Swedish autoclaved potato cubes;

E: Eko autoclaved potato cubes; and

F: Swedish pasteurised potato cubes.

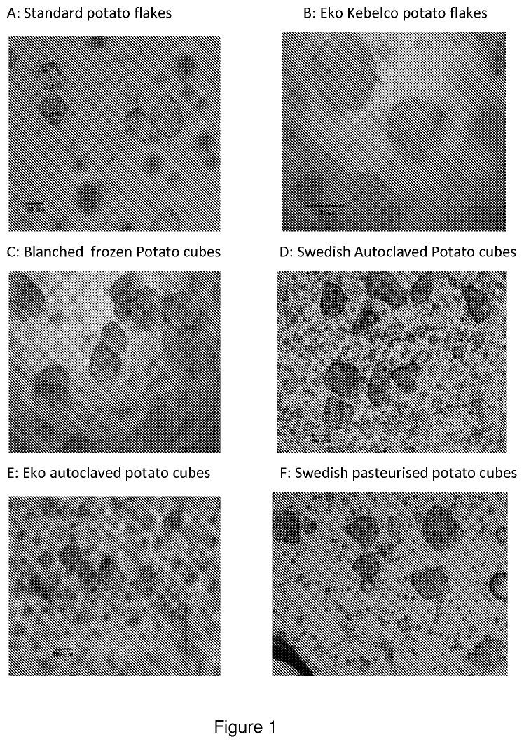

The light micrographs of the starch granules in the different forms of potato studied can be viewed in FIG. 1 A-F.

### Light Microscopy Observation

Microscopy observation were performed according to the following:

Sample (of smoothie, emulsion, or soup) were prepared by:

Shaking the samples for 5 times; Putting one droplet of smoothie in a small tube;

Diluting it with 5 water droplets; Stirring by using the pipet.

The diluted sample was then placed on the object glass in the microscope. The lens UMPlan FI 5x/0.15 (to get 50× magnification) was used for starch granules observation and the lens UMPlan FI 10x/0.3 (to get 100x magnification) for oil droplets observation.

### Determination of Particle Size Distribution PSD

The particle size distribution (PSD) of the emulsion droplets (d32) and the starch granules (d43) has been measured using a laser diffraction analyser (Malvern Mastersizer). The mean particle size can be calculated based on the volume or the area occupied by the particles, expressed as d₄₃ and d₃₂, respectively.

$${d}_{43} = {\sum }_{i} {n}_{i} {d}_{i}^{4} \text{/} {\sum }_{i} {n}_{i} {d}_{i}^{3}$$

$${d}_{32} = {\sum }_{i} {n}_{i} {d}_{i}^{3} \text{/} {\sum }_{i} {n}_{i} {d}_{i}^{2}$$

Where nᵢ is the percentage of particles with diameter dᵢ.

### Determination of the Consistency Rheology Measurements

The consistency of the smoothies was performed by measuring the visco-elastic properties at a temperature of 25° C. using a controll-stress rheometer (Malvern, Kinexus) to perform oscillatory tests. The elastic modulus (G′) at the linear visco-elastic region was determined by applying a stress sweep test from 0.01 to 10 Pa at 1 Hz.

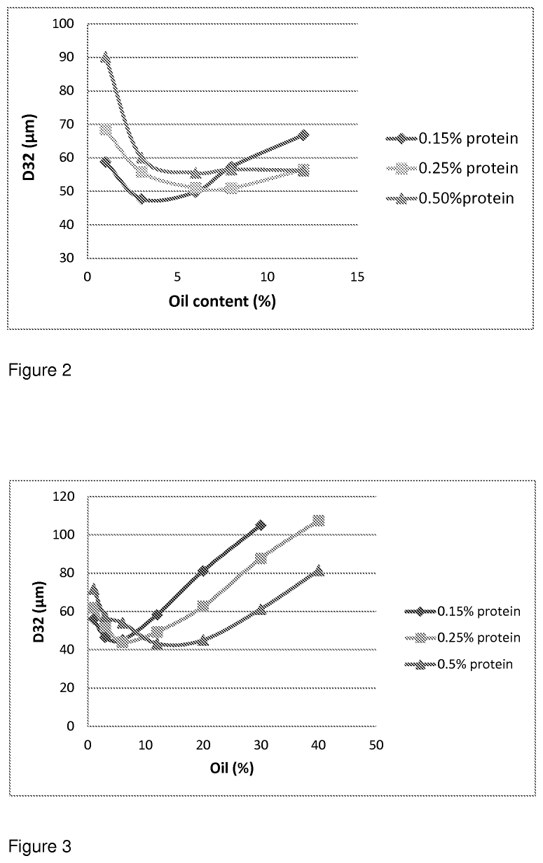

In the diagrams shown in FIGS. 2-7 it can be seen the size distributions of the oil droplets (d₃₂) and the starch granules (d₄₃), respectively, obtained when using differently processed potato as the potato raw material as well as increasing amount of oil and protein content in the smoothies:

The emulsions obtained with Example 1 were investigated regarding the size of the oil droplets (d₃₂ μm) as a function of the oil (1-12%) and protein content (0.15-0.50%). The results are shown in FIG. 2.

The emulsions obtained with Example 4 were investigated regarding the size of the oil droplets (d₃₂ μm) as a function of the oil (1-40%) and protein content (0.15-0.50%). The results are shown in FIG. 3.

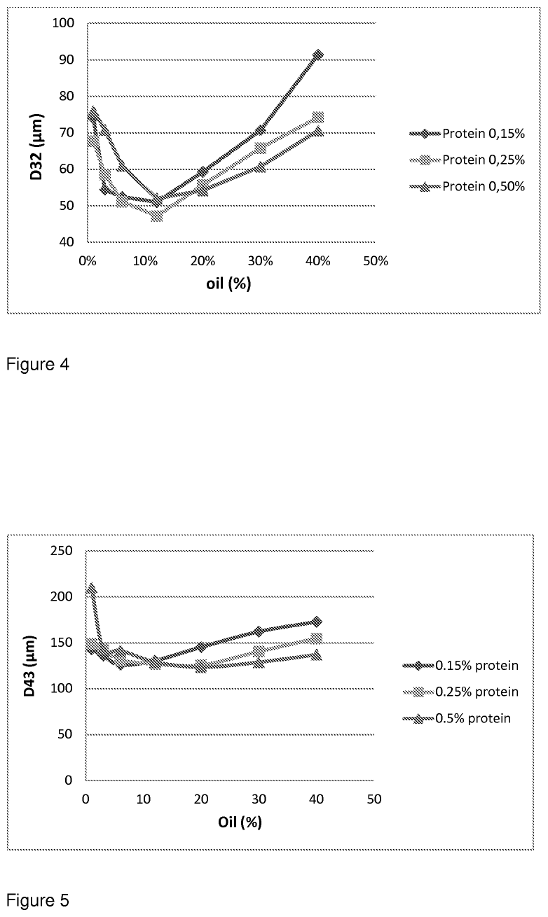

The emulsions obtained with Example 6 were investigated regarding the size of the oil droplets (d₃₂ μm) as a function of the oil (1-40%) and protein content (0.15-0.50%). The results are shown in FIG. 4.

The smallest oil droplets were obtained from 6 to about 12% oil and 0.25% protein seems to be the optimal potato protein concentration for most of the emulsions studied. All droplet sizes are well below 90 μm except at the highest oil concentrations of 30-40%.

When making smoothies based on blanched and frozen potatoes oil droplets as high as 90-100 μm was achieved.

The emulsions obtained with Example 4 were also investigated regarding the size of starch granules (d₄₃ μm) as a function of the oil (1-40%) and protein content (0.15-0.50%). The results are presented in FIG. 5.

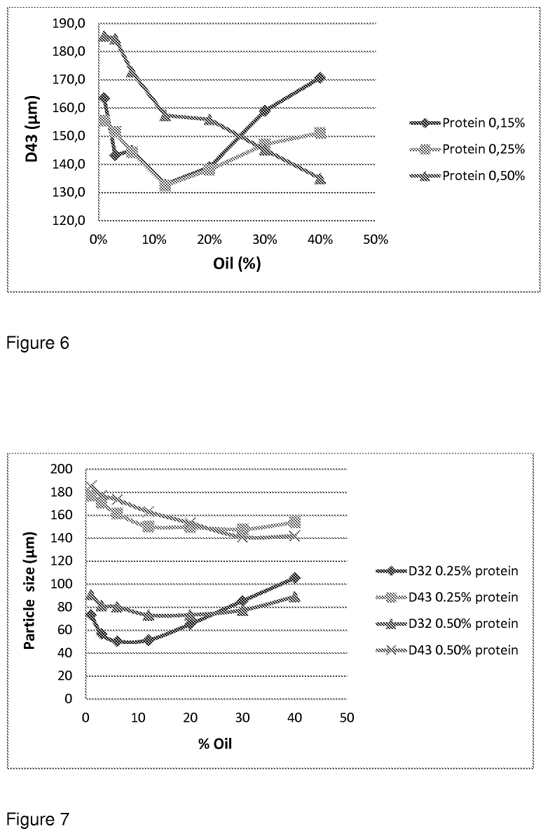

The emulsions obtained with Example 6 were also investigated regarding the size of starch granules (d₄₃ μm) as a function of the oil (1-40%) and protein content (0.15-0.50%). The results are presented in FIG. 6.

The emulsions obtained with Example 2 were also investigated regarding both the size of the oil droplets (d₃₂) and starch granules (d₄₃ μm) as a function of the oil (1-40%) and protein (0.25-0.50%) content. The results are shown in FIG. 7.

The size of the starch granules are naturally not so dependent on the oil content as the oil droplet size. The protein content follows the starch content so with higher protein content the higher the amount of starch, which in turn gives rise to a more viscous water phase in the emulsion. For the autoclaved potato the variation in starch granule size is not that dependent on either oil or protein content, whereas for the pasteurised potato the smallest granules round 130 μm are obtained at an oil concentration of about 12% and the two lowest protein concentrations. It can be noted that at the highest protein and oil concentration also a small granular size of 135 μm is achieved. All these phenomena are considered connected with the viscosity of the continous phase which will be referred to below. The starch granules of the potato flakes are also well below 250 μm, whereas for the blanched and frozen potato the associated granules gave rise to such large sizes as 390 μm.

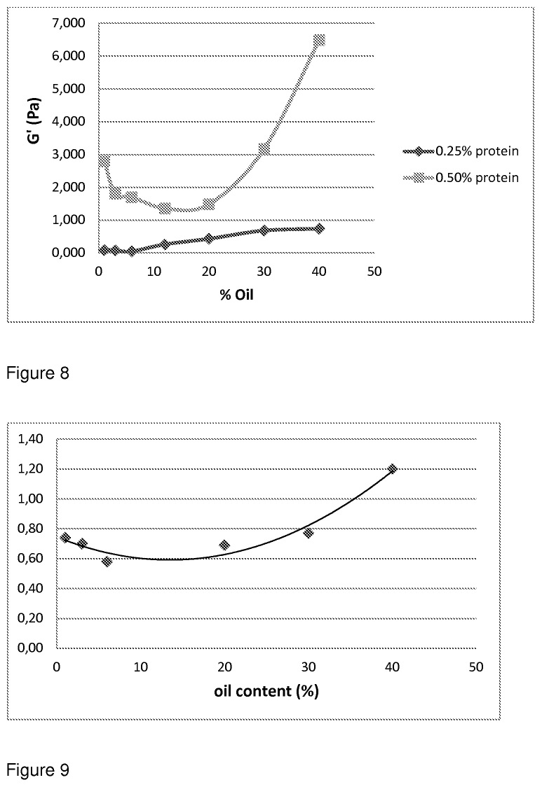

Further, the consistency of emulsions obtained with Example 2 has been tested. The results are shown in FIG. 8 wherein G′ (Pa) as a function of the oil (1-40%) and protein content (0.25-0.50%) is presented.

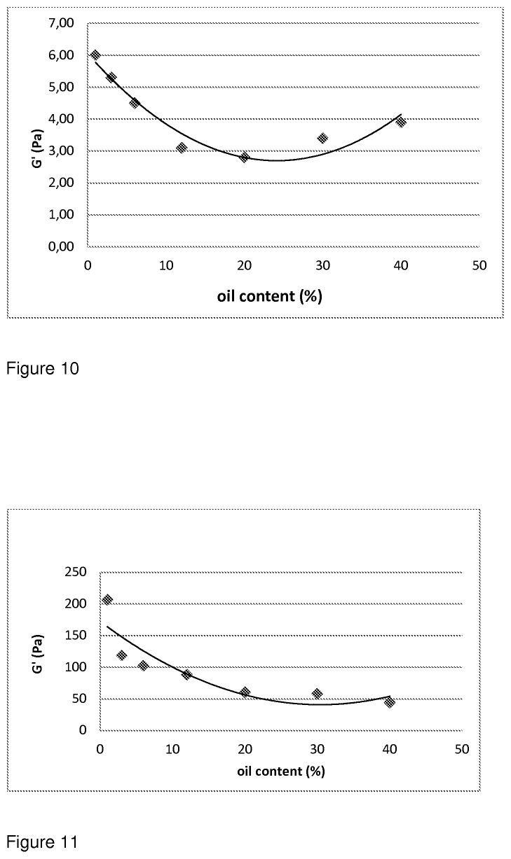

Also, the emulsions (A-C) obtained according to Example 4 were investigated regarding their consistency (G′(Pa)). The results are shown in FIG. 9 (protein content 0,15%), FIG. 10 (protein content 0,25%), and FIG. 11 (protein content 0,50%), respectively, as a function of the oil content (1-40%).

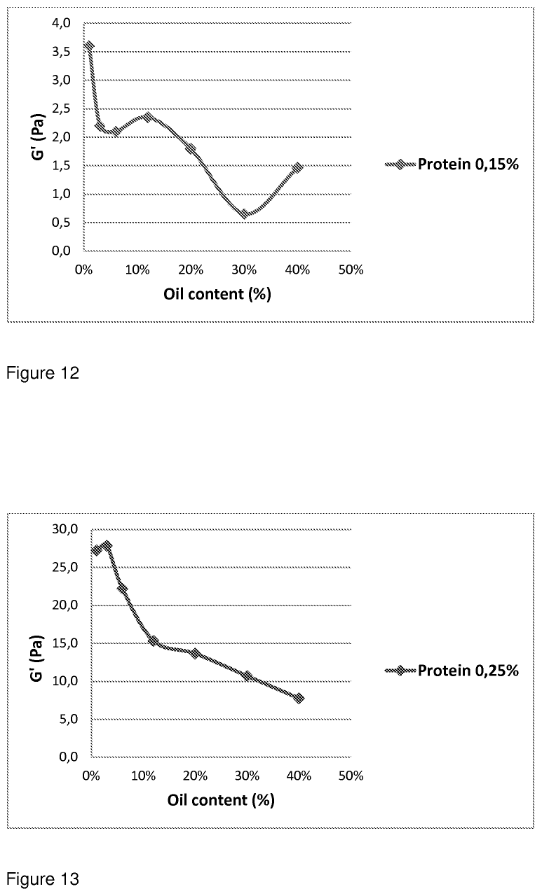

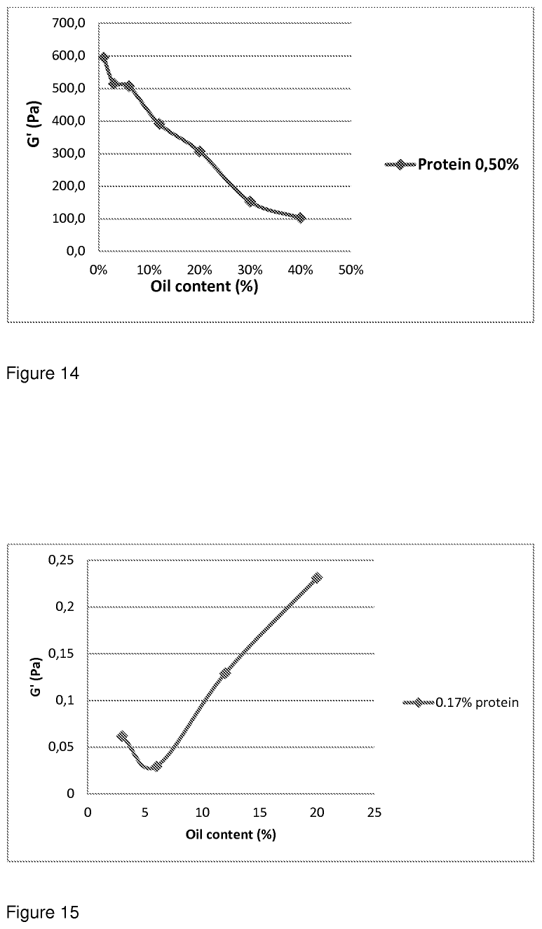

Also, the emulsions (A-C) obtained according to Example 6 were investigated regarding their consistency (G′(Pa)). The results are shown in FIG. 12 (protein content 0,15%), FIG. 13 (protein content 0,25%), and FIG. 14 (protein content 0,50%), respectively, as a function of the oil content (1-40%).

The emulsions obtained according to Example 3 were investigated regarding its consistency (G′(Pa)). The results are shown in FIG. 15 as a function of the oil content (1-20%) having a protein content of 0,17%.

Usually with increasing oil content the consistency is enhanced but this is only the case with the potato emulsions having the lowest viscosity, i.e. the emulsions made out of blanched and frozen potatoes and Eko kebelco potato flakes. Especially the blanched and frozen potato emulsions have a very low elastic modulus (G′) of 0.23 Pa with 20% oil and a protein concentration of 0.17%, whereas the emulsions based on Swedish autoclaved potato cubes and Swedish pasteurised potato cubes give a G′ of 0.6 and 1.8 Pa, respectively, at the same oil concentration of 20% using a lower protein content of 0.15%. Using the higher protein contents of 0.25 and 0.50% for the Swedish autoclaved potato cubes and Swedish pasteurised potato cubes substantially higher viscosities can be achieved especially for the pasteurised potato, where in the latter case G′:s as high as 100-600 Pa can be obtained. For emulsions with this high consistency however the viscosity is lowered with increasing oil content, but still with an oil content of 6% and a protein concentration of 0.50% a G′ of 500 Pa is achieved for the pasteurised potato. This is the neighbourhood of the consistency of a bearnaise sauce for example, which implies another application area for these type of potato based emulsions. Evidenly, the capacity to form a good consistency in the water phase of the emulsion is very dependent on the type of processing the potato has been subjected to before being used in the potato based emulsion. The best type of processing of the potato seems so far to be the pasteurised potato.

### Example 7 : Industrial Preparation of Smoothie

Smoothies with berries, such as sea buckthorn, blueberry and raspberry added have also been made industrially at an amount of about 2 tons each. The potato source was Kebelco Eco potato flakes to a concentration of 3% and the rapeseed oil concentration was 6%, berry addition 10% and the rest was apple juice. The smoothies produced had good colour and consistency and tasted good. The measurements of the oil droplets D[3,2] and starch granules D[4,3]can be seen below and they are within limits set by the patent.

| Sample | D[3, 2] | D[4, 3] |
|---|---|---|
| Raspberry Eco | 64.260 | 180.029 |
| | 60.685 | 186.636 |
| Blueberry Eco | 67.848 | 185.594 |
| | 66.098 | 188.789 |
| Buckthorn Eco | 63.978 | 181.545 |
| | 63.176 | 168.809 |

While the invention has been described in connection with what is presently considered to be the most practical embodiments, it is to be understood that the invention is not to be limited to the disclosed embodiments, but on the contrary, it is intended to cover various modifications and equivalents included within the spirit and scope of the appended claims.

1-11. (canceled)

12. A stable, potato based emulsion comprising:
a) 1-40% by weight of at least one vegetable oil;
b) 1-65% by weight of heat treated potato, wherein the heat treated potato is chosen from potato flakes heated to at least 100° C. or whole and/or potato cubes pasteurized at 98° C., or autoclaved at about 115-121° C.;
c) 5-30% by weight of at least one fruit or vegetable; and
d) optionally adding water up to 100% by weight,
wherein oil drops present in the emulsion have a d₃₂ of less than 90 μm and starch particles originating from the heat treated potato have a diameter of less than 250 μm, and wherein a majority of the starch particles are non-associated.

13. A stable, potato based emulsion according to claim 12, wherein the at least one vegetable oil is chosen from rapeseed oil, olive oil, maize oil, sunflower oil, soybean oil, coconut oil, peanut oil, and sesame oil.

14. A stable, potato based emulsion according to claim 12, wherein the at least one fruit is chosen from apple, banana, citrus fruit, pear, pineapple, mango, passion fruit, papaya, or berry, said berry chosen from strawberry, raspberry, blueberry, black currant, red currant, sea buckthorn, blackberry, and lingonberry.

15. A stable, potato based emulsion according to claim 13, wherein the at least one fruit is chosen from apple, banana, citrus fruit, pear, pineapple, mango, passion fruit, papaya, or berry, said berry chosen from strawberry, raspberry, blueberry, black currant, red currant, sea buckthorn, blackberry, and lingonberry.

16. A stable, potato based emulsion according to claim 12, wherein the at least one vegetable is chosen from onion, broccoli, parsnip, carrot, mushroom, tomato, leek, red beat.

17. A stable, potato based emulsion according to claim 13, wherein the at least one vegetable is chosen from onion, broccoli, parsnip, carrot, mushroom, tomato, leek, red beat.

18. A stable, potato based emulsion according to claim 12, wherein said oil drops have a diameter in an inclusive range of 30 μm through 90 μm.

19. A stable, potato based emulsion according to claim 18, wherein said oil drops have a diameter in an inclusive range of 30 μm through 80 μm.

20. A stable, potato based emulsion according to claim 19, wherein said a diameter in an inclusive range of 30 μm through 40 μm.

21. A stable, potato based emulsion according to claim 13 wherein said oil drops have a diameter in an inclusive range of 30 μm through 90 μm.

22. A stable, potato based emulsion according to claim 21, wherein said oil drops have a diameter in an inclusive range of 30 μm through 80 μm.

23. A stable, potato based emulsion according to claim 22, wherein said a diameter in an inclusive range of 30 μm through 40 μm.

24. A stable, potato based emulsion according to claim 12, wherein the starch particles have a diameter in an inclusive range of 100 μm through 250 μm.

25. A stable, potato based emulsion according to claim 24, wherein the starch particles have a diameter in an inclusive range of 120 μm through 190 μm.

26. A stable, potato based emulsion according to claim 25, wherein the starch particles have a diameter in an inclusive range of 140 μm through 170 μm.

27. A stable, potato based emulsion according to claim 13, wherein the starch particles have a diameter in an inclusive range of 100 μm through 250 μm.

28. A stable, potato based emulsion according to claim 27, wherein the starch particles have a diameter in an inclusive range of 120 μm through 190 μm.

29. A stable, potato based emulsion according to claim 28, wherein the starch particles have a diameter in an inclusive range of 140 μm through 170 μm.

30. A stable, potato based emulsion according to claim 14, wherein said a diameter in an inclusive range of 30 μm through 40 μm.

31. A stable, potato based emulsion according to claim 14, wherein the starch particles have a diameter in an inclusive range of 140 μm through 170 μm.
